(19) United States
(12) Patent Application Publication
(10) Pub. No.: US 2010/0320408 A1
(43) Pub. Date: Dec. 23, 2010

(54) FLUID CONTROLLER

(75) Inventors: Tomohiro Nakata, Osaka-shi (JP); Michio Yamaji, Osaka-shi (JP); Tsutomu Shinohara, Osaka-shi (JP); Akihiro Harada, Osaka-shi (JP)

Correspondence Address: EDWARDS ANGELL PALMER & DODGE LLP, P.O. BOX 55874, BOSTON, MA, 02205, US

(73) Assignee: FUJIKIN INCORPORATED, Osaka-shi, Osaka (JP)

(21) Appl. No.: 12/449,375

(22) PCT Filed: Jan. 30, 2008
(86) PCT No.: PCT/JP2008/051349

§ 371 Date: Aug. 5, 2009

(30) Foreign Application Priority Data
Feb. 6, 2007 (JP) 2007-026647

(51) Int. Cl. F16K 1/54

(52) U.S. Cl. 251/205

(57) ABSTRACT

The present invention provides a fluid controller which enables fine adjustments of low flow rates and enables a user to set desired low flow rates. Low-flow-rate piston stop-position setting means 12, which sets a position at which a low-flow-rate piston stops in upward movement thereof, includes: a low-flow-rate control screw 31 which is screwed in a through screw hole 15a provided in the top wall 15 of a casing 4 in such a way as to provide a gap between itself and the upper end surface of a valve rod 5, a tapered portion 32 provided at the tip end portion of the low-flow-rate control screw 31, a stopper piston 33 which has, in an upper surface thereof, a tapered portion 34 facing to the tapered portion 32 with a predetermined interval interposed therebetween and also has a lower surface 33a for restricting the upper position at which the low-flow-rate piston 8 stops, and a plurality of force transmission spherical members 35 which are interposed between the tapered portion 32 of the low-flow-rate control screw 31 and the tapered portion 34 of the stopper piston 33 for transmitting force therebetween.

### TECHNICAL FIELD

The present invention relates to a fluid controller having a structure capable of positioning a valve rod at any of a close position, a high-flow-rate open position and a low-flow-rate open position existing between the close position and the high-flow-rate open position, and capable of changing over a flow rate of a fluid between a high flow rate and a low flow rate.

### BACKGROUND ART

As a fluid controller capable of changing over between a high flow rate and a low flow rate, Patent Document 1 discloses a fluid controller including a valve body provided with a fluid channel, a casing provided on an upper portion of the valve body, a valve rod which upwardly and downwardly moves a valve element for opening and closing the fluid channel, an elastic member which biases the valve rod downwardly, a low-flow-rate piston which is mounted to an upper end portion of the valve rod and is moved upwardly and downwardly integrally with the valve rod, a high-flow-rate piston which is mounted to the valve rod under the low-flow-rate piston and is moved upwardly and downwardly integrally with the valve rod, low-flow-rate piston driving means which moves the low-flow-rate piston upwardly, high-flow-rate piston driving means which moves the high-flow-rate piston upwardly, low-flow-rate piston stop-position setting means which defines a position at which the low-flow-rate piston stops in an upward movement thereof, and high-flow-rate piston stop-position setting means which defines a position at which the high-flow-rate piston stops in the upward movement thereof, the fluid controller being capable of positioning the valve rod at any of a close position, a high-flow-rate open position and a low-flow-rate open position existing between the close position and the high-flow-rate open position, wherein the low-flow-rate piston stop-position setting means includes a low-flow-rate control screw which is screwed in an upper end portion of a casing peripheral wall and functions as a casing cover, such that the lower surface of the screw defines the upward position at which the low-flow-rate piston stops.

Patent Document 1: Japanese Unexamined Patent Publication No. 2001-27354

### SUMMARY OF THE INVENTION

### Problems to be Solved by the Invention

With the fluid controller in Patent Document 1, the low-flow-rate control screw has a pitch of about 1 mm and, therefore, there is a need for making adjustments within a range of number-of-rotations from 0 to 0.3, which makes it hard for a user to make fine adjustments of low flow rates. Therefore, a manufacturer should make such adjustments.

It is an object of the present invention to provide a fluid controller which enables fine adjustments of low flow rates and enables the user to set a desired low flow rate.

### Means for Solving the Problems

A fluid controller according to the present invention includes: a valve body provided with a fluid channel; a casing provided on an upper portion of the valve body; a valve rod which upwardly and downwardly moves a valve element for opening and closing the fluid channel; an elastic member which biases the valve rod downwardly; a low-flow-rate piston which is mounted to an upper end portion of the valve rod and moves upwardly and downwardly integrally with the valve rod; a high-flow-rate piston which is mounted to the valve rod under the low-flow-rate piston and moves upwardly and downwardly integrally with the valve rod; low-flow-rate piston driving means which moves the low-flow-rate piston upwardly; high-flow-rate piston driving means which moves the high-flow-rate piston upwardly; low-flow-rate piston stop-position setting means which sets a position at which the low-flow-rate piston stops in an upward movement thereof; and high-flow-rate piston stop-position setting means which sets a position at which the high-flow-rate piston stops in an upward movement thereof, the fluid controller being capable of positioning the valve rod at any of a close position, a high-flow-rate open position and a low-flow-rate open position existing between the close position and the high-flow-rate open position, wherein the low-flow-rate piston stop-position setting means includes a low-flow-rate control screw which is screwed in a top wall of the casing so as to provide a gap between itself and an upper end surface of the valve rod, a tapered portion provided at a tip end portion of the low-flow-rate control screw, a stopper piston which has, in an upper surface thereof, a tapered portion facing to the tapered portion provided at a tip end portion of the low-flow-rate control screw with a predetermined interval interposed therebetween and also has a lower surface for restricting an upper stop position of the low-flow-rate piston, and a plurality of force-transmission members which are interposed between the tapered portion provided at the tip end portion of the low-flow-rate control screw and the tapered portion of the stopper piston for transmitting force between the tapered portions.

The close position is provided when there exists only the biasing force of the elastic member (such as a compression coil spring). The high-flow-rate open position is provided when the high-flow-rate piston has been moved upwardly by the high-flow-rate piston driving means. The low-flow-rate open position is provided when the low-flow-rate piston has been moved upwardly by the low-flow-rate piston driving means.

Each of the tapered portions may be formed to have a conical surface, and the force transmission members may be formed as spherical members. In this case, the spherical members are provided in plural numbers (for example, 3 to 8) in the circumferential direction. Also, each of the tapered portions may be formed to have a wedge shape, and the force transmission members may be formed to have a cylindrical shape. In this case, the force transmission members are provided in a pair, and have a cross-sectional shape with two circles (the cross sections of the force transmission members) and an isosceles triangle (the cross section of the wedge-shaped tapered portion) interposed therebetween.

The high-flow-rate piston and the low-flow-rate piston are mounted to the valve rod at predetermined positions movably in the upward and downward directions and, also, are prevented from upwardly moving by the stop rings secured to the valve rod. Accordingly, if the high-flow-rate piston and the low-flow-rate piston are moved upwardly, they come into contact with the stop rings and, and thereafter moved upwardly integrally with the valve rod. On the contrary, if the valve rod is moved downwardly, the stop rings come into contact with the pistons and, therefore, the pistons are moved downwardly integrally with the valve rod.

The low-flow-rate piston driving means and the high-flow-rate piston driving means are adapted to introduce compressed air into the enclosed spaces (the air introducing chambers) formed under the low-flow-rate piston and the high-flow-rate piston. In this case, when no compressed air is introduced, the valve rod is biased by the elastic member and is positioned at the close position. If compressed air is introduced into the air introducing chamber under the low-flow-rate piston, the valve rod (the valve element) is positioned at a first open position at which the valve rod is displaced upwardly by an amount corresponding to the upward movement of the low-flow-rate piston. If compressed air is introduced into the air introducing chamber under the high-flow-rate piston, the valve rod (the valve element) is positioned at a second open position at which the valve rod is displaced upwardly by an amount corresponding to the upward movement of the high-flow-rate piston. Further, by setting the amount of movement of the high-flow-rate piston to be larger than the amount of movement of the low-flow-rate piston, it is possible to set the first open position as the low-flow-rate open position and the second open position as the high-flow-rate open position, thereby enabling adjustment of the flow rate in two steps.

The low-flow-rate piston stop-position setting means is capable of adjusting the position at which the low-flow-rate piston stops. The high-flow-rate piston stop-position setting means is not required to make adjustment and is required only to stop the valve rod at the high-flow-rate open position (the full-open position). The high-flow-rate piston stop-position setting means can be either adapted to prevent the high-flow-rate piston from being moved upwardly more than required due to the low-flow-rate piston contacting with the stopper piston or adapted to prevent the valve rod itself from being moved upwardly beyond a predetermined position, by forming a step portion which comes into contact with a flange portion provided in the valve rod, in a member secured to the casing.

The low-flow-rate piston stop-position setting means is adapted to adjust the position of the stopper piston which comes into contact with the low-flow-rate piston being moved upwardly, for example, by rotating the low-flow-rate control screw with a screwdriver. The stopper piston is formed to have a shape similar to those of the low-flow-rate piston and the high-flow-rate piston and is fitted within the casing movably in the upward and downward directions above the low-flow-rate piston. The angle of tapering of the tapered portion of the low-flow-rate control screw and the angle of tapering of the tapered portion of the stopper piston define the amount of movement of the stopper piston with respect to the amount of movement of the low-flow-rate control screw. By setting these angles of tapering to predetermined values, it is possible to easily adjust the upper and lower positions of the stopper piston, thereby enabling adjustment of the flow rate to a desired value in cases of low flow rates.

With the fluid controller with the aforementioned structure, it is possible to adjust the flow rate in two steps while keeping it closed. For example, the fluid controller can be used for flowing a nitrogen gas at a low flow rate at first and then flowing the nitrogen gas at a high flow rate, when it is desired not to flow the nitrogen gas into a vacuum chamber at once. In addition, the fluid controller can be used for discharging air within a hydraulic circuit (a bright valve, a leak valve or the like).

### Effects of the Invention

With the fluid controller according to the present invention, by adjusting the angle of tapering of the tapered portion of the low-flow-rate control screw and the angle of tapering of the tapered portion of the stopper piston, it is possible to set the amount of movement of the stopper piston to be extremely small (for example, 1/10) with respect to the amount of movement of the low-flow-rate control screw. This enables fine adjustments of low flow rates, thereby enabling a user to make adjustments.

### BRIEF DESCRIPTION OF THE DRAWINGS

FIG. 1 is a cross-sectional view illustrating a first embodiment of a fluid controller according to the present invention.

FIG. 2 is a plan view of the same.

FIG. 3 is a graph illustrating a relationship between rotational angles of a low-flow-rate control screw in the fluid controller according to the present invention and Cv values, in comparison with a conventional structure.

FIG. 4 is a cross-sectional view illustrating a second embodiment of the fluid controller according to the present invention.

### DESCRIPTION OF THE REFERENCE NUMERALS

(1) Fluid controller
(2) Valve body
(2a) Fluid inlet channel (fluid channel)
(2b) Fluid outlet channel (fluid channel)
(4) Casing
(5) Valve rod
(6) Diaphragm (valve element)
(7) Compression coil spring (elastic member)
(8) Low-flow-rate piston
(9) High-flow-rate piston
(10) Low-flow-rate piston driving means
(11) High-flow-rate piston driving means
(12)(40) Low-flow-rate piston stop-position setting means
(13) High-flow-rate piston stop-position setting means
(15) Cover (top wall)
(15a) Through screw hole
(31) Low-flow-rate control screw
(32) (42) Tapered portion
(33) (43) Stopper piston
(33a) (43a) Lower surface
(34) (44) Tapered portion
(35) Force transmission spherical member (force transmission member)
(45) Force transmission cylindrical member (force transmission member)

### PREFERRED EMBODIMENTS FOR CARRYING OUT THE INVENTION

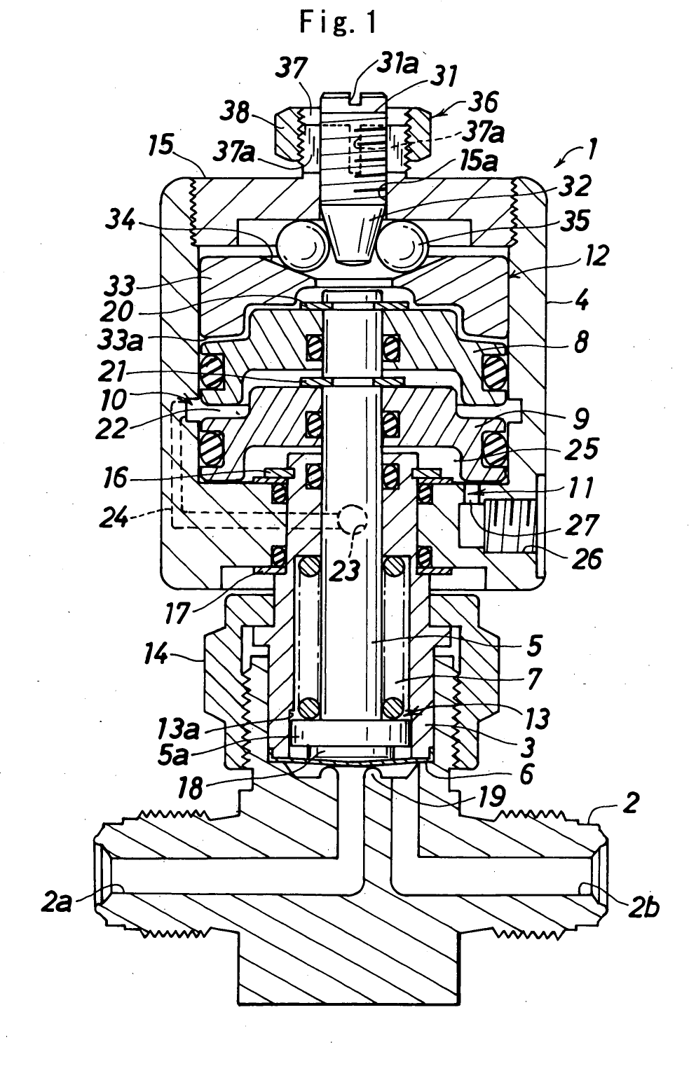

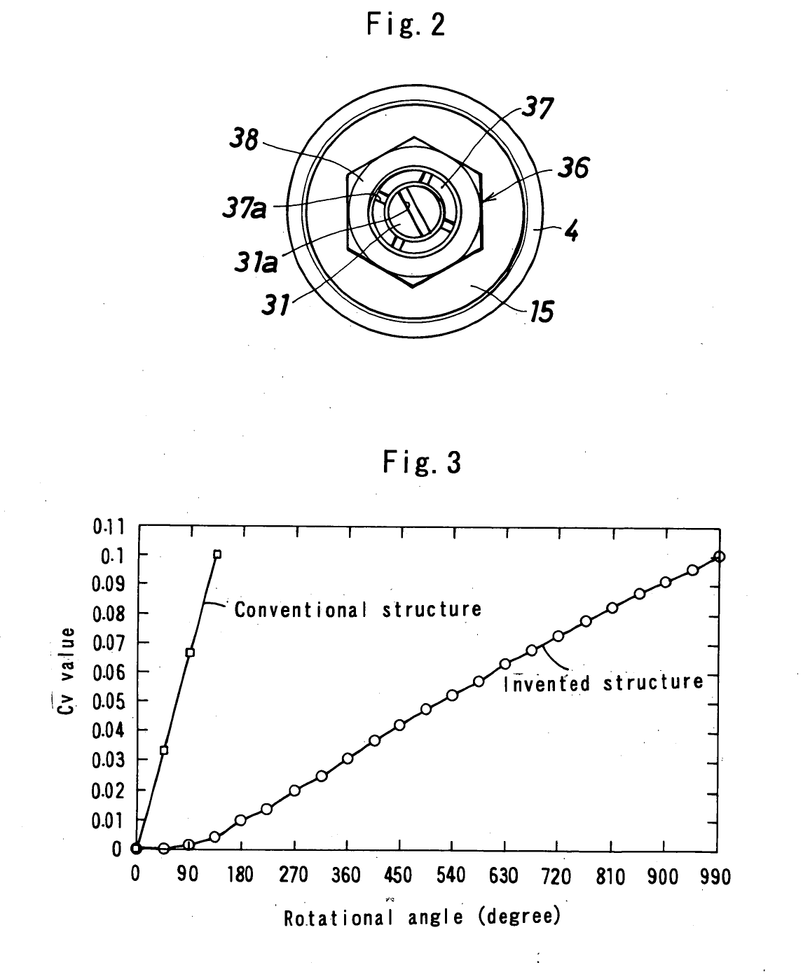

Hereinafter, embodiments of the present invention will be described with reference to the drawings. In the following description, the terms “upper”, “lower”, “left” and “right” mean upper, lower, left and right portions of FIG. 1.

As illustrated in FIG. 1, a fluid controller (1) according to a first embodiment of the present invention includes a valve body (2) provided with a fluid inlet channel (2a) and a fluid outlet channel (2b), a bonnet (3) secured to an upper portion of the valve body (2), a casing (4) secured to an upper end portion of the bonnet (3), a valve rod (5) which is inserted in the bonnet (3) movably in upward and downward directions and an upper portion thereof existing within the casing (4), a diaphragm (valve element) (6) which opens and closes the fluid inlet channel (2a) along with the upward and downward movement of the valve rod (5), a compression coil spring (7) as an elastic member which biases the valve rod (5) downwardly, a low-flow-rate piston (8) which is mounted to the upper end portion of the valve rod (5) and moves upwardly and downwardly integrally with the valve rod (5), a high-flow-rate piston (9) which is mounted to the valve rod (5) under the low-flow-rate piston (8) and moves upwardly and downwardly integrally with the valve rod (5), a low-flow-rate piston driving means (10) which moves the low-flow-rate piston (8) upwardly using compressed air introduced from the outside, a high-flow-rate piston driving means (11) which moves the high-flow-rate piston (9) upwardly using compressed air introduced from the outside, a low-flow-rate piston stop-position setting means (12) which defines a position at which the low-flow-rate piston stops in upward movement thereof, and a high-flow-rate piston stop-position setting means (13) which defines a position at which the high-flow-rate piston stops in upward movement thereof, wherein the valve rod (5) can be positioned at any of a close position of when there exists only the biasing force of the compression coil spring (7), a high-flow-rate open position of when the high-flow-rate piston (9) has been moved upwardly, and a low-flow-rate open position of when the low-flow-rate piston (9) has been moved upwardly, the low-flow-rate open position existing between the close position and the high-flow-rate open position. FIG. 1 illustrates a state where the valve rod (5) exists at the close position.

The bonnet (3) is fitted at its lower end portion within an upwardly-opened recess provided at the upper end portion of the valve body (2) and is secured to the valve body (2) through a bonnet nut (14). The casing (4) is upwardly opened, and the opening thereof is closed by a cover (15). The bonnet (3) is inserted at its upper portion in a bonnet insertion hole provided in the bottom wall of the casing (4) in a fluid tight manner, and stop rings (16) and (17) are fitted to the upper end portion and a middle portion of the bonnet (3) protruded upwardly from the bottom wall of the casing (4), respectively, so that the bonnet (3) and the casing (4) are coupled to each other.

The valve rod (5) is inserted in the upper end portion of the bonnet (3) movably in the upward and downward directions in a fluid tight manner, and the valve rod (5) is provided with a flange portion (5a) at its lower end portion. The bonnet (3) is provided with a step portion (13a) which defines the upper position of the flange portion (5a).

The compression coil spring (7) is housed within an inner peripheral portion of a middle portion of the bonnet (3) and is received by the flange portion (5a) of the valve rod (5) and by a step portion provided at an upper portion of the bonnet (3).

A diaphragm presser (18) is secured to the lower surface of the flange portion (5a) of the valve rod (5), and the diaphragm (6) is pressed by the diaphragm presser (18) biased downwardly by the elastic force of the compression coil spring (7) at the close position illustrated in FIG. 1, so that the diaphragm (6) is pressed against an annular valve seat (19) provided at the opening of the fluid inlet channel (2a) in the valve body (2).

The low-flow-rate piston (8) and the high-flow-rate piston (9) are each formed to have a disk shape having an annular downward protruding edge portion and are mounted to the valve rod (5) at predetermined positions and fitted within the casing (4) movably in the upward and downward directions in a fluid tight manner. The valve rod (5) extends upwardly by penetrating through the two pistons (8) and (9). At the close position illustrated in FIG. 1, the high-flow-rate piston (9) is downwardly pressed integrally with the valve rod (5) being downwardly biased by the compression coil spring (7), so that the annular downward protruding edge portion on the lower surface of the bottom wall thereof is brought into contact with the upper surface of the bottom wall of the casing (4).

Stop rings (20) and (21) are secured to the valve rod (5) such that they are brought into contact with the respective upper surfaces of the low-flow-rate piston (8) and the high-flow-rate piston (9). With this configuration, if the low-flow-rate piston (8) and the high-flow-rate piston (9) are moved upwardly, the valve rod (5) moves upwardly integrally therewith and, if the valve rod (5) is moved downwardly, the low-flow-rate piston (8) and the high-flow-rate piston (9) move downwardly integrally therewith. Note that the stop rings (20) and (21) do not restrict the downward movement of the low-flow-rate piston (8) and the high-flow-rate piston (9) with respect to the valve rod (5).

The low-flow-rate driving means (10) is adapted to introduce compressed air into a low-flow-rate air introducing chamber (22) formed between the lower surface of the low-flow-rate piston (8) and the upper surface of the high-flow-rate piston (9). The low-flow-rate driving means (10) includes a low-flow-rate port (23) which is provided in a side surface of the bottom wall of the casing (4) and communicated with a compressed-air source and, further includes a casing internal channel (24) which extends from the low-flow-rate port (23) to the low-flow-rate air introducing chamber (22) through the insides of the bottom wall and the peripheral wall of the casing (4).

The high-flow-rate driving means (11) is adapted to introduce compressed air into a high-flow-rate air introducing chamber (25) formed between the bottom wall of the casing (4) and the lower surface of the high-flow-rate piston (9). The high-flow-rate driving means (11) includes a high-flow-rate port (26) which is provided in the bottom wall of the casing (4) and communicated with the compressed-air source and, further includes a casing-bottom-wall internal channel (27) which extends from the high-flow-rate port (26) to the high-flow-rate air introducing chamber (25) through the inside of the bottom wall of the casing (4).

The low-flow-rate piston stop-position setting means (12) includes a low-flow-rate control screw (31) which is screwed in a through screw hole (15a) provided in the cover (15) as the top wall of the casing (4) in such a way as to provide a gap between itself and the upper end surface of the valve rod (5), a tapered portion (32) with a narrow tip which is provided at the tip end portion of the low-flow-rate control screw (31), a stopper piston (33) which has a recessed tapered portion (34) in the upper surface such that it is faced to the tapered portion (32) with a predetermined interval interposed therebetween and also has a lower surface (33a) for restricting the upper position at which the low-flow-rate piston (8) stops, four force-transmission spherical members (35) as force-transmission members which are interposed between the tapered portion (32) of the low-flow-rate control screw (31) and the tapered portion (34) of the stopper piston (33) for transmitting force therebetween, and low-flow-rate control screw fixture means (36) for fixing the low-flow-rate control screw (31).

In the upper surface of the low-flow-rate control screw (31), there is formed an engagement slot (31a) for fitting a screwdriver thereto.

The tapered portion (32) of the low-flow-rate control screw (31) and the tapered portion (34) of the stopper piston (33) are both formed to have a conical shape with a center axis coincident with the center axis of the valve rod (5). The angle of tapering of the tapered portion (32) of the low-flow-rate control screw (31) is made to be an acute angle, while the tapered portion (34) of the stopper piston (33) is formed to have an obtuse angle. By adjusting these angles of tapering, it is possible to set the amount of movement of the stopper piston (33) to be, for example, 1/10 the amount of movement of the low-flow-rate control screw (31). Note that the gap between the upper surface of the low-flow-rate piston (8) and the lower surface of the stopper piston (33) is extremely small, in actual, but is exaggeratedly illustrated in the figure.

The spherical members (35) are made of hard materials, such as steel balls, other metal balls or ceramic balls, and are rotatably fitted in the slot formed in the stopper piston (33).

The low-flow-rate control screw fixture means (36) includes a hollow male screw portion (37) which is provided to have an upward protruding shape at the center portion of the cover (15) and is adapted such that the low-flow-rate control screw (31) is screwed therein, and a lock nut (38) with a tapered screw for reducing the diameter of the male screw portion (37). The male screw portion (37) is provided with four slots (37a), so that tightening of the lock nut (38) induces a radially-inward force in the male screw portion (37), thereby locking the low-flow-rate control screw (31).

The high-flow-rate piston stop-position setting means (13) is formed by adjusting, to a predetermined interval, the distance between the lower surface of the low-flow-rate piston (8) and the stop ring (21) defining the upper position of the high-flow-rate piston (9).

With the fluid controller (1) according to the present invention, if compressed air is introduced into the low-flow-rate air introducing chamber (22) through the low-flow-rate port (23) at a state where the channel is closed, the low-flow-rate piston (8) moves upwardly, thereby moving the valve rod (5) upwardly along therewith. As a result, the upper surface of the low-flow-rate piston (8) comes into contact with the lower surface of the stopper piston (33). Accordingly, the valve rod (5) is held at the low-flow-rate open position. Thereafter, if compressed air is introduced into the high-flow-rate air introducing chamber (25) through the high-flow-rate port (26), the high-flow-rate piston (9) moves upwardly, thereby bringing the stop ring (21) existing on the upper surface of the high-flow-rate piston (9) into contact with the lower surface of the low-flow-rate piston (8). This prevents the high-flow-rate piston (9) from moving anymore, thereby holding the valve rod (5) at the high-flow-rate open position.

As described above, with the fluid controller (1) according to the present invention, it is possible to hold the valve rod (5) at any of the low-flow-rate open position, the high-flow-rate open position and the close position, by selecting any of introduction of compressed air through the low-flow-rate port (23), introduction of compressed air through the high-flow-rate port (26) and introduction of no air.

FIG. 3 illustrates the relationship between rotational angles of the low-flow-rate control screw (31) and Cv values in the case of using the fluid controller (1) according to the present invention. This relationship is determined by rotating the low-flow-rate control screw (31), with respect to the position which makes the low flow rate to be zero, in steps of 45 degrees in the leftward direction from this position, then tightening the lock nut (38) at the respective positions for locking it, then measuring the flow rates thereat and then calculating the Cv values from the measurement values. As can be seen from the figure, a conventional structure does not enable adjustments with Cv values of 0.01 or less substantially, but the fluid controller (1) according to the present invention easily enables adjustments even with Cv values of 0.01 or less.

Note that, in the aforementioned first embodiment, although the respective tapered portions (32) and (34) are formed to have conical surfaces and the force transmission members (35) are formed as spherical members, the tapered portions and the force transmission members are not limited thereto. Such an embodiment will be described below.

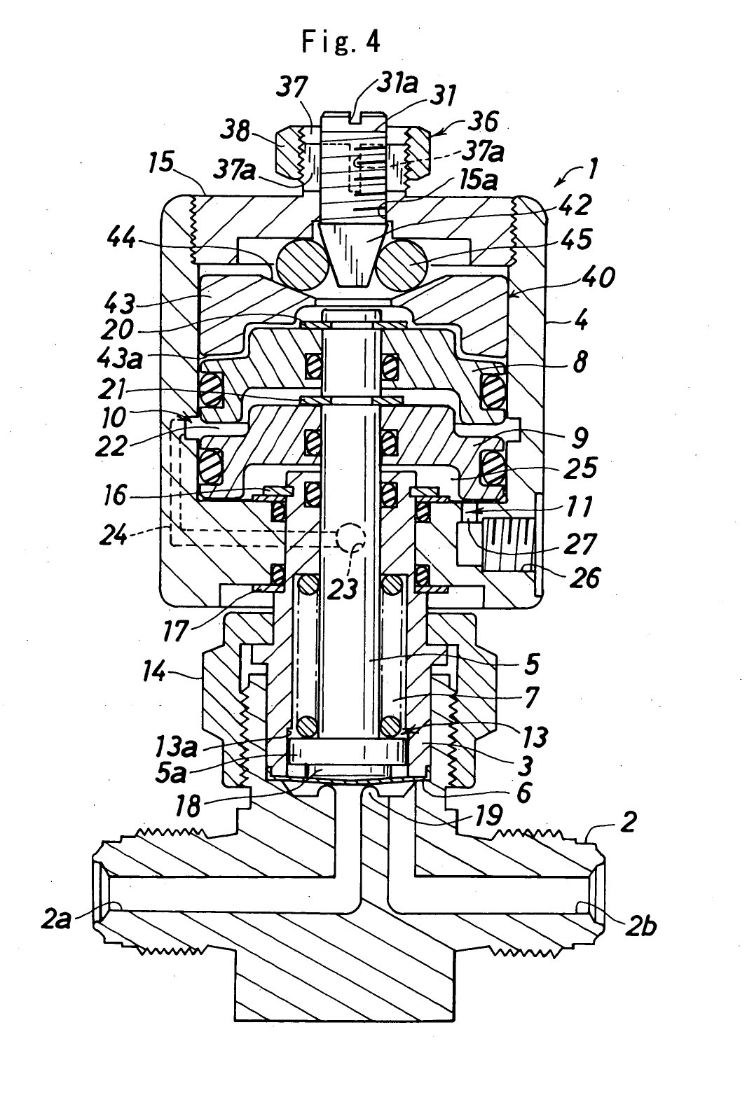

The second embodiment of the fluid controller (1) according to the present invention illustrated in FIG. 4 is different from the first embodiment illustrated in FIG. 1, in the structures of the low-flow-rate piston stop-position setting means (12) and (40). In the following description, the same structures will be designated by the same reference numerals and the descriptions thereof will not be given.

The low-flow-rate piston stop-position setting means (40) includes, similar to that according to the first embodiment, a low-flow-rate control screw (31) which is screwed in a through screw hole (15a) provided in the cover (15) as the top wall of the casing (4) in such a way as to provide a gap between itself and the upper end surface of the valve rod (5), a tapered portion (42) with a narrow tip which is provided at the tip end portion of the low-flow-rate control screw (31), a stopper piston (43) which has a recessed tapered portion (44) at the upper surface such that it is faced to the tapered portion (42) with a predetermined interval interposed therebetween and has a lower surface (43a) which restricts the upper position at which the low-flow-rate piston (8) stops, force-transmission members (45) which are interposed between the tapered portion (42) provided at the tip end portion of the low-flow-rate screw (31) and the tapered portion (44) of the stopper piston (43) for transmitting force therebetween, and a low-flow-rate control screw fixture means (36) for fixing the low-flow-rate control screw (31), however, the structures of the tapered portion (42) provided at the tip end portion of the low-flow-rate screw (31), the stopper piston (43), and the force transmission members (45) are different from those of the first embodiment.

The force transmission members (45) according to the second embodiment are not spheres and are formed as a pair of force transmission cylindrical members which are arranged symmetrically about the center axis of the valve rod (5) and also have an axis extending from the front side of the paper plane of FIG. 4 to the back side thereof. Further, in conformance therewith, the tapered portion (42) provided at the tip end portion of the low-flow-rate control screw (31) and the tapered portion (44) of the stopper piston (43) are both formed to have a wedge shape having a symmetrical axis coincident with the center axis of the valve rod (5). In FIG. 4, the inclined surfaces of each of the tapered portions (42) and (44) extend in the same shape from the front side of the paper plane to the back side thereof, thereby providing a cross-sectional shape having two circles (the cross sections of the force transmission members) and an isosceles triangle (the cross section of the wedge-shaped tapered portion) interposed therebetween.

The lower surface (43a) of the stopper piston (43) which restricts the upper position at which the low-flow-rate piston (8) stops is formed to have the same shape as that of the lower surface (33a) of the stopper piston (33) according to the first embodiment.

The tapered portion (the wedge-shaped member) (42) provided at the tip end portion of the low-flow-rate control screw (31) is formed as a member separated from the low-flow-rate control screw (31) (the tapered portion (32) provided at the tip end portion of the low-flow-rate control screw (31) according to the first embodiment is formed integrally with the tip end portion of the low-flow-rate control screw (31). The wedge-shaped member (42) forming the tapered portion is coupled to the tip end portion of the low-flow-rate control screw (31) such that, when the low-flow-rate control screw (31) is rotated, the wedge-shaped member (42) moves integrally therewith upwardly or downwardly, while being prevented from rotating.

The angle of tapering of the tapered portion (42) provided at the tip end portion of the low-flow-rate control screw (31) is formed to be an acute angle, while the tapered portion (44) of the stopper piston (43) is formed to have an obtuse angle. By adjusting these angles of tapering, it is possible to set the amount of movement of the stopper piston (43) to be, for example, 1/10 the amount of movement of the low-flow-rate control screw (31), similarly to the first embodiment.

### INDUSTRIAL APPLICABILITY

With a fluid controller according to the present invention, it is possible to change over a flow rate of a fluid between a high flow rate and a low flow rate and, it is also possible to enable a user to set a desired low flow rate, which contributes to an improvement of usability of the fluid controller.

1. A fluid controller comprising: a valve body provided with a fluid channel; a casing provided on an upper portion of the valve body; a valve rod which upwardly and downwardly moves a valve element for opening and closing the fluid channel; an elastic member which biases the valve rod downwardly; a low-flow-rate piston which is mounted to an upper end portion of the valve rod and moves upwardly and downwardly integrally with the valve rod; a high-flow-rate piston which is mounted to the valve rod under the low-flow-rate piston and moves upwardly and downwardly integrally with the valve rod; low-flow-rate piston driving means which moves the low-flow-rate piston upwardly; high-flow-rate piston driving means which moves the high-flow-rate piston upwardly; low-flow-rate piston stop-position setting means which sets a position at which the low-flow-rate piston stops in an upward movement thereof; and high-flow-rate piston stop-position setting means which sets a position at which the high-flow-rate piston stops in an upward movement thereof, the fluid controller being capable of positioning the valve rod at any of a close position, a high-flow-rate open position and a low-flow-rate open position existing between the close position and the high-flow-rate open position,
wherein the low-flow-rate piston stop-position setting means includes a low-flow-rate control screw which is screwed in a top wall of the casing so as to provide a gap between itself and an upper end surface of the valve rod, a tapered portion provided at a tip end portion of the low-flow-rate control screw, a stopper piston which has, in an upper surface thereof, a tapered portion facing to the tapered portion provided at the tip end portion of the low-flow-rate control screw with a predetermined interval interposed therebetween and also has a lower surface for restricting an upper stop position of the low-flow-rate piston, and a plurality of force-transmission members which are interposed between the tapered portion provided at the tip end portion of the low-flow-rate control screw and the tapered portion of the stopper piston for transmitting force therebetween.

2. The fluid controller according to claim 1, wherein
each of the tapered portions is formed to have a conical surface having a center axis coincident with a center axis of the valve rod, the force transmission members are formed as spherical members, and the spherical members are arranged in plural numbers in a circumferential direction.

3. The fluid controller according to claim 1, wherein
each of the tapered portions is formed to have a wedge shape having a symmetric axis coincident with a center axis of the valve rod, the force transmission members are formed to have a cylindrical shape, and the force transmission members are arranged in a pair symmetrically about the symmetric axis of each of the tapered portions.

4. The fluid controller according to claim 2, wherein
an angle of tapering of the tapered portion provided at the tip end portion of the low-flow-rate control screw is an acute angle, while the tapered portion of the stopper piston has an obtuse angle.

5. The fluid controller according to claim 1, wherein
a stopper piston is movably fitted within the casing in upward and downward directions above the low-flow-rate piston.

6. The fluid controller according to claim 3, wherein
an angle of tapering of the tapered portion provided at the tip end portion of the low-flow-rate control screw is an acute angle, while the tapered portion of the stopper piston has an obtuse angle.
